(19) United States
(12) Patent Application Publication
(10) Pub. No.: US 2012/0296798 A1
(43) Pub. Date: Nov. 22, 2012

(54) Flexible-rate, financial option and method of trading

(76) Inventors: Michael A. Riddle, JR., Palatine, IL (US); Donald R. Wilson, JR., Chicago, IL (US); Kevin Wolf, New York, NY (US); Yuhua Yu, Chicago, IL (US)

(21) Appl. No.: 13/506,407

(22) Filed: Apr. 17, 2012

Related U.S. Application Data
(63) Continuation-in-part of application No. 13/068,781, filed on May 19, 2011.

(51) Int. Cl. G06Q 40/04

(52) U.S. Cl. 705/37

(57) ABSTRACT

A flexible-rate option and method of electronic trading are provided. The flexible-rate option includes a negotiable premium and a corresponding rate-based strike rate. At least one discount curve, and potentially also a forward curve are determined An adjustment factor for the financial instrument is determined. The curve or curves are used to determine the adjustment factor to determine the adjusted exercise price of an underlying with a standardized coupon as the present value difference between the delivered financial instrument with a fixed rate and a swap with the strike rate, at or near the time of option exercise. This Abstract is submitted with the understanding that it will not be used to interpret or limit the scope or meaning of the claims.

### RELATED APPLICATION

This application is a Continuation-in-Part to U.S. patent application Ser. No. 13/068,781 titled “Rate-Negotiated, Standardized Coupon Financial Instrument”, filed 19 May 2011, the contents of which are incorporated herein by this reference.

### FIELD OF THE INVENTION

The present invention relates to financial instruments, and to the electronic clearing and settling of such financial instruments.

### BACKGROUND OF THE INVENTION

Varieties of different types of financial instruments are traded throughout the world. Examples include cash contracts and derivatives. A cash contract is an agreement to deliver the specified asset. A derivative is a financial instrument whose value is linked to the price of an underlying commodity, asset, rate, index, currency or the occurrence or magnitude of an event. Typical examples of derivatives include futures, forwards, options, swaps, and swap futures.

Most commonly, a swap is an agreement between two parties to exchange sequences of cash flows for a set period of time. Usually, at the time the swap is initiated, at least one of these series of cash flows is benchmarked to an asset or an index that is variable, such as an interest rate, foreign exchange rate, equity price or commodity price. A swap may also be used to exchange one security for another to change the maturity (bonds), quality of issues (stocks or bonds) or to facilitate a change in investment objectives.

A nomenclature has developed to describe the characteristics of certain swaps. A “plain-vanilla” swap is one that only has the simplest and most common terms. A “spot” starting swap is one where the economics of the swap start almost immediately upon two parties entering into the swap. A “seasoned” swap is one that has been in existence for some time. A “forward-starting” swap is one where the first calculation date (effective date) of the swap does not commence until a designated point in the future. The parties to a forward-starting swap are still responsible for performing their obligations, but these obligations do not start for a period of time after the parties have agreed to enter into the swap. An “off-market” swap is one that has a value other than zero.

The first swap occurred between IBM and the World Bank in 1981. Although swaps have only been trading since the early 1980's, they have exploded in popularity. In 1987, the swaps market had a total notional value of $865.6 billion; by mid-2006, this figure exceeded $250 trillion. That is more than 15 times the size of the U.S. public equities market.

The most common type of swap is an interest rate swap. In a plain-vanilla, interest rate swap, two parties agree to exchange periodic interest payments, typically when one payment is at a fixed rate and the other varies according to the performance of an underlying reference rate. Interest rate swaps are generally quoted in yield (rate) terms, especially for par swaps. Conceptually, an interest rate swap can be viewed as either a portfolio of forwards, or as a long (short) position in a fixed-rate bond coupled with a short (long) position in a floating-rate bond. Commonly, for U.S. dollar denominated interest rate swaps, the rate quoted is the fixed rate that the market expects will offset future 3-month London InterBank Offered Rate (LIBOR) (or whatever underlying reference rate is specified in the swap). (LIBOR refers to a daily reference rate based on the interest rates at which banks borrow unsecured funds from other banks in the London wholesale interbank market.) Cash then flows on a periodic basis between the buyer and the seller depending on the difference between the fixed rate and the floating rate. For example, one party (Party A) agrees to pay another party (Party B) a predetermined, fixed rate of interest on a notional amount on specific dates for a specified period of time; concurrently, Party B agrees to pay Party A floating interest rate on that same notional amount on the same specified dates for the same specified time period. Interest payments may be made annually, quarterly, monthly or at any other interval determined by the parties. Examples of other reference rates include the Tokyo Interbank Offered Rate (TIBOR), the Euro Interbank Offered Rate (EURIBOR), Euro OverNight Index Average (EONIA), and the like.

Other than plain-vanilla interest rate swaps, float-for-float swaps (also known as basis swaps) are widely used in the market place as hedging and investment tools. A float-float swap involves the exchange of two floating payments with different reference rates between counterparties. The frequency of the two floating payments may or may not be same. For example, in a 3/6 LIBOR basis swap, one party (Party A) agrees to pay another party (Party B) floating interest rate tied to 3-month LIBOR on a predetermined notional amount every three months; concurrently, Party B agrees to pay Party A floating interest rate tied to 6-month LIBOR on that same notional amount every 6 months. In a Fed Funds/LIBOR basis swap, one floating payment is determined by the Federal Funds Effective overnight rate over a certain period, and the other floating payment is determined by LIBOR. The interest payments are commonly made every quarter in a Fed Funds/LIBOR basis swap. The Federal Funds Effective overnight rate is the interest rate at which a depository institution lends immediately available funds to another depository institution overnight.

Another financial instrument commonly traded within the OTC market today is an option on a swap. An option on an interest rate swap is commonly referred to as a ‘swaption’, though a swaption could be based on any type of underlying swap. Traditional swaptions, as well as options on swap futures, herein collectively referred to as swaptions, grant their owner the right, but not the obligation to enter into the underlying swap (or swap futures) according to the terms of the option.

A payer swaption gives the owner of the swaption the right to enter into a swap, where the owner pays the fixed leg and receives the floating leg. A receiver swaption gives the owner of the swaption the right to enter into a swap, where the owner receives the fixed leg and pays the floating leg.

Swaption characteristics to which the counterparties must agree include price (in premium terms), the strike rate (rate-based strike price that represents the coupon value of the fixed leg of the underlying swap upon exercise of the option), time to maturity of the option, effective date of the underlying swap, tenor of the underlying swap, notional amount, and other customizable features of the underlying swap, such as payment schedule and amortization. It is worth noting how the strike rate differs from strikes of a traditional option on futures or other assets, such as US treasury options or mid-curve Eurodollar options traded on CME. The strike of a traditional option is the exercise price that the owner of the option pays to assume the long or short position of the underlying upon exercise. In the current convention of a swaption, the exercise price is effectively 0, and the strike rate is the fixed coupon rate of the swap that the owner of the swaption will pay (payer swaption) or receive (receiver swaption) upon exercise. An option on a swap can be physically-delivered, in which the counterparties to the option position, upon exercise, become counterparties to an underlying swap position. Alternatively, an option on a swap can be cash-settled in which, upon exercise, the counterparties to the option position exchange the monetary value associated with delivering the underlying swap and liquidating it immediately at prevailing market rates. The CME Group is located at 20 South Wacker Drive, Chicago, Ill. 60606.

William Lawton is generally credited with inventing the swaption in 1983. Lawton was the Head Trader for Fixed Income Derivatives at First Interstate Bank in Los Angeles at that time. Lawton married the concept of an interest rate swap and an option. The swaption was for a period of one year. First Interstate, for a premium, sold a Los Angeles based savings and loan the right to enter into a five-year interest rate swap to pay fixed versus three-month LIBOR on a notional amount of $5 million. See, for example, http://www.reference.com/browse/forward+swap (accessed 7 Apr. 2012).

Standardized derivatives have traditionally been exchange-traded and centrally-cleared financial instruments; swaps, on the other hand, have traditionally been customized financial instruments that are traded in the over-the-counter (OTC) market. (The OTC market has historically referred to privately negotiated trades between two parties that are not centrally cleared (that is, uncleared)). Each party looks solely to the other party for performance and is thus exposed to the credit risk of the other party (often referred to as counterparty risk). Unlike financial instruments that are centrally cleared, there is no independent guarantor of performance. Uncleared financial instruments are often transacted pursuant to International Swaps and Derivatives Association (ISDA) master documentation. The ISDA, 360 Madison Avenue, 16th Floor, New York, N.Y. 10017 is an association formed by the privately negotiated derivatives market that represents participating parties.

It is common for collateral to change hands as the value of an uncleared position changes. The party that has an unrealized loss on an open, uncleared position will post collateral with the party that has the unrealized gain in order to secure its liability. A common form of collateral is obligations of the United States Treasury (for example, Treasury Bonds, Notes, and Bills). When a Treasury obligation is posted as collateral, price changes in that financial instrument and coupon payments accrue to the owner of the collateral, that being the party posting the financial instrument. Cash may also be posted as collateral, in which case the party receiving the cash as collateral is obligated to pay interest to the party posting the cash collateral at a rate set by agreement between the parties. When the trade is unwound or expires, the party holding the collateral returns it to the other party, and the trade is ultimately settled.

Financial instruments traded on exchanges are distinctly different from uncleared financial instruments. While the economics of the two may be similar, futures and options on futures (futures options) are traded on and pursuant to the rules of an exchange. Unlike uncleared financial instruments where the parties set the terms of the trade, exchange-listed futures and futures options are standardized. Such terms include notional amount, price change per increment, expiration date, and how the financial instrument is settled (either cash settlement or physical delivery) at expiration. The only attributes that matter for parties to negotiate in futures, other than which party is the buyer and which party is the seller, is the number of financial instruments to be traded and the price.

All futures and futures options are centrally cleared, with a central counterparty exchanging payments and collections between counterparties on a regular basis. This is quite different from uncleared financial instruments discussed above. Central clearing means that the counterparty risk is drastically reduced. The parties to a trade cease to be counterparties to each other; rather, each party faces a clearinghouse and looks solely to the clearinghouse for clearing trades, collecting and maintaining margin, regulating delivery, and reporting trading data.

Traditional, uncleared OTC interest rate swaps can be divided into two categories: ‘par swaps’, where the initial value of the two legs (the payments that one party pays and receives) are equal; and ‘off-market swaps’, where one of the legs is more valuable than the other leg when measured in net present value (NPV) terms.

In an uncleared par swap, counterparties often times do not exchange cash or securities at the time of the trade. As the value of the position deviates from par over the life of the uncleared par swap, counterparties exchange collateral according to the terms of their ISDA rules. In a cleared par swap, counterparties are typically required to post cash or other securities to a clearing agent at the time of the trade, to serve as ‘initial margin’, which is also known as ‘performance bond’. The purpose of the initial margin is to ensure that if one counterparty defaults on the trade at a later time by failing to make required payments, the clearing agent can liquidate the position and have sufficient capital available (including the value of the liquidated swap position, and the liquidation value of original collateral posted as initial margin) to pay the non-defaulting counterparty the full amount due.

Typically, a trader who desires to enter into a par swap contacts a dealer bank (dealer) to find out what fixed coupon rate the dealer will offer as par for a swap defined by certain characteristics. These characteristics can include effective date, fixing date, tenor, maturity date, index, fixed leg payment intervals, floating leg payment intervals, fixed leg day count convention, floating leg day count convention, and holiday calendar, among others. The par coupon rate is expressed in terms of percentage of notional value, and defines the total annual payments due from fixed leg payer to the fixed leg receiver. For example, a par coupon rate of 3.005% on a swap with a notional value of $100 million implies that the fixed leg payer agrees to pay the fixed leg receiver approximately $3,005,000 per year for the tenor of the swap, with such annual amount being divided over the number of payments within the year. The most common fixed leg payment interval is semiannual, implying a payment amount of approximately $1,502,500 every six months in this example. The payment amounts above are designated as approximate, rather than exact, to account for the potential for variability due to specific day counts on the fixed leg.

Before a par swap trade is consummated, the counterparties must agree on the ‘par coupon’, which is the fixed rate coupon that implies an NPV of zero, considering the characteristics of the swap and forecasted future interest rates. Swap traders employ a variety of publicly-available and custom tools to calculate the appropriate par coupon rate, including market data services (for example, Bloomberg L. P., 731 Lexington Avenue, New York, N.Y. 10022 and Thomson Reuters, 3 Times Square, New York, N.Y. 10036); analytical software packages (for example, the RiskVal RVFI Platform, available from RiskVal Financial Solutions, 120 West 31st Street, New York, N.Y. 10001 and SuperDerivatives SDX Interest Rates, available from SuperDerivatives Inc., 545 Madison Avenue, 17th Floor, New York, N.Y. 10022); and custom-constructed software and spreadsheets.

A typical example of a tool used extensively by swap traders for calculating the par coupon of a given swap is the Bloomberg SWPM page. On the Bloomberg SWPM page, a swap trader can input the characteristics of a swap as described above, and the SWPM page will examine current forecasted interest rates, calculate the fixed coupon rate that implies an NPV of zero (fixed leg present value (PV) minus floating leg PV equals zero), and outputs this value to the user as the par coupon.

Similar to the par coupon in plain-vanilla swaps, counterparties who trade a basis swap at par must agree on a ‘par spread’. Par spread is the interest payment added to one floating leg such that the present value of this leg is equal to the present value of the other floating leg at the time of trading.

The term off-market swap is often used to refer to swaps that have a fair market NPV other than zero at the time of the trade. This NPV must be agreed upon by the counterparties for a trade to be consummated, and this negotiated NPV can be viewed as the price of the trade. In an uncleared swap, the negotiated NPV is paid from one counterparty to the other counterparty at the time of the trade as an ‘upfront payment’, generally in cash. As yet, no clear standard market convention has emerged for central counterparties to accommodate off-market swaps for cleared interest rate swaps and cleared swap futures. One method, employed by International Derivatives Clearing Group, LLC (IDCG), 150 East 52nd Street, 5th Floor, New York, N.Y. 10022, is to have the counterparties exchange upfront payments at the time of the trade, in a bilateral fashion without involving the central counterparty.

Another method, employed by CME Group's CME Clearing for cleared interest rate swaps, is to have the upfront payment be exchanged between the counterparties through the central counterparty on the same day that the trade is marked in the favor of the counterparty making the upfront payment. This effectively nets out the payment amounts, except for any presumably small difference between the negotiated upfront payment amount and the actual deviation from fair market value determined by the central counterparty.

A third method, employed by CME Clearing for clearing Eris Exchange futures, is to embed the negotiated upfront payment amount into the reference price of the trade itself, and then pay/collect variation margin between the parties only insofar as the fair market value of the future deviates from that trade price in the future. The Eris Exchange, 311 South Wacker Drive, Suite 950, Chicago, Ill. 60606 is a futures exchange operating as Designated Contract Market under the jurisdiction of the Commodity Futures Trading Commission (CFTC).

To initiate a negotiation of price (in NPV terms) for a given off-market swap, the counterparties must first agree on the swap characteristics discussed above. In addition, the counterparties must also agree on the fixed rate coupon of the plain-vanilla swap (or spread in the case of the basis swap), to provide sufficient data to evaluate the NPV of the swap. Once the parties agree on a negotiated NPV, the trade is consummated. The following table summarizes the way that NPV and Fixed Rate are agreed upon for plain-vanilla par swaps and off-market swaps:

| | Defined Prior to | Agreed upon during |
|---|---|---|
| | Negotiation | negotiation |
| Par Swap | NPV = 0 | Par Coupon (Fixed Rate) |
| Off-Market Swap | Fixed Rate | NPV (upfront payment) |

Since the spread in a basis swap can be treated as a special form of a coupon, the terms of coupon and spread will not be explicitly distinguished in the following discussion. Coupon is used herein to refer to both the fixed rate coupon in a plain-vanilla swap or spread in a basis swap.

For a number of reasons, the majority of trades in the interest rate swap market are negotiated in rate terms as par swaps, for which market participants demonstrate a clear preference. OTC par swaps typically do not involve an upfront exchange of cash between the counterparties. Many bilateral swaps executed under an ISDA Master Agreement do not require either counterparty to post initial margin (referred to as Independent Amount under a Credit Support Annex to an ISDA Master Agreement), and by definition a par swap has an NPV of zero at the time of the trade, requiring neither counterparty to post collateral to the other upon trade inception. Cleared par swap derivatives, on the other hand, require each counterparty to post initial margin to the central counterparty (CCP) shortly after trade execution.

OTC off-market swaps require an upfront exchange of cash between the counterparties to offset the difference expected value of the future cash flows. Market participants properly recognize the implicit loan that is embedded in this transaction, in that the value exchanged from one counterparty is repaid in periodic installments to the other counterparty throughout the life of the swap, all else being equal. For trades that are not fully collateralized or cleared, to ensure that appropriate returns are earned for this lending, the majority of OTC dealers employ internal funding models within their banks, to ensure that swap traders properly incorporate lending and borrowing rates on upfront payments for all off-market swaps, and tear-up payments related to unwinds.

Additionally, off-market swaps sometimes require accounting treatment deemed to be unfavorable by swap counterparties. Certain firms use swaps only if they can construct them in such a way as to obtain a specific application of hedge accounting treatment under the Financial Accounting Standards Board (FASB) standards outlined in FAS133. Obtaining this treatment ensures that the changes in value of the swap over the course of the duration of the swap do not get reported through the income statement of the firm. Off-market swaps with upfront payments may be disqualified from receiving the most desirable form of accounting treatment. The FASB establishes standards of financial accounting and reporting nongovernmental entities.

The factors related to off-market swaps—especially upfront payments that amount to off-balance sheet loans that require funding and invoke unfavorable accounting treatment—are further reasons that explain the clear preference among market participants to trade OTC interest rate swaps as par swaps. The relative popularity of par swaps compared to off-market swaps may be largely attributable to the upfront payment issue, but also may be self-reinforcing over time. Given the maturity of the swap market and the amount of tools available to traders that focus analysis on par swaps, attempts to list swap-like products that do not trade as par swaps will be forced to overcome what will be referred to herein as the preference for par swaps issue.

Traditional futures are defined by expiration dates that are generally monthly or quarterly, and trading volume tends to be concentrated in monthly or quarterly futures that mature within three months to two years of a given trading date. Today, a party can buy (go long) 10-Eurodollar futures that expire in six months, and on any trading day in that six-month period, can re-enter the market and trade out of the initial position by selling (go short) 10-Eurodollar futures that carry the same expiration date. Regardless of the futures price negotiated for each trade, the result of the two trades is that the trader will have no liability and carry no position, or be ‘net flat’ in futures industry parlance. The standardized nature of futures results in concentration of liquidity within the central limit order book, as multiple trading participants place bids and offers to trade a quarterly-expiring future at various prices.

The characteristics of cleared, interest rate swap derivatives (either interest rate swaps that are cleared or interest rate swap futures with flexible coupons) imply significantly different trading and liquidity characteristics from traditional futures. A spot-starting financial instrument traded today is a different financial instrument from the spot-starting financial instrument traded tomorrow. And each coupon rate that trades as par for a given day and tenor is an independent financial instrument. Traditionally, the most frequently-traded spot-starting swaps have so-called standard maturity dates or standard tenors, traded in increments of one-year (for example, 2-year, 3-year, 5-year, 7-year, 10-year).

The granularization of financial instruments available for trading results in relatively low levels of open interest occurring for each individual financial instrument. This can add difficulty for a given trader to find willing buyers and sellers to act as counterparties at reasonable prices. This is referred to herein as the granularization issue.

Options on swaps may suffer from the granularization issue in two respects. First, trading options on swaps in strike rate terms using sub-basis point increments results in a proliferation of distinct financial instruments. Each financial instrument has relatively low open interest, which can add difficulty for a given trader looking to exit the position prior to expiration to find willing buyers and sellers to act as counterparties at reasonable prices. Second, a trader: with a portfolio of multiple swaptions at distinct strike rates will receive positions upon exercise in underlying swaps at distinct fixed rates, thereby becoming subject to the granulariziation issue for the swaps themselves.

Recognition of the granularization issue in swaps can be observed empirically in the recent migration toward more standardized coupons among traders of credit default swaps. Such migration is industry-led in response to some of the issues described above, rather than being spurred by regulatory mandate. http://www.markit.com/cds/announcements/resource/cds_big_bang.pdf (accessed 11 Apr. 2012). Other swap markets, including interest rate swaps, have been slower to move toward coupon standardization, but may do so in the future.

Each financial instrument must have a value assigned to it for purposes of daily valuation, and in centrally-cleared markets, the clearinghouse assigns this value. To determine the value of a futures position, participants use price per future, then multiply that value by the total number of futures held by a counterparty. To determine the value of a swaps position, participants use NPV of remaining cash flows.

Eris Exchange introduced Eris Exchange Interest Rate Swap Futures (Eris IR Swap Futures) in August 2010. This financial instrument is regulated as a future, but contains economic and date flexibility characteristics typically associated with interest rate swaps. For example, Eris IR Swap Futures allow counterparties to initiate par swap positions by negotiating the fixed coupon rate, as described above. The Eris IR Swap Futures allowed participants to trade spot-starting financial instruments with effective dates t+2 (two business days after the trade date), that mature on any valid business day up to 30 years in the future.

Starting in October 2011, Eris Exchange featured for trading forward-starting Eris IR Swap Futures with effective dates up to ten years in the future, cleared by CME Clearing. The daily mark-to-market valuation process for Eris IR Swap Futures results in cash flows that are similar to total cash flows that a participant would derive from an identically-structured, fully collateralized OTC interest rate swap, assuming both (the Eris IR Swap Future and the OTC interest rate swap) are valued daily using a common set of discount factors and forward rates. This flexibility contrasts with the characteristics of the CME Group's Chicago Board of Trade 5-year and 10-year Interest Rate Swap futures (CBOT Swap Futures). CBOT Swap Futures include a standard fixed rate of 4%, are only forward-starting, with quarterly effective dates which are also expiration dates, and do not replicate the economics of an equivalent swap position. OTC swaps and Eris IR Swap Futures are outstanding until the maturity date, with no prior expiration. By allowing participants to trade interest rate swap derivatives in a futures form, Eris Exchange permits multiple counterparties to submit anonymous bids and offers in a central limit order book through an electronic trading platform.

Typically, a trader who desires to enter into an option on an interest rate swap contacts a dealer to find out what fixed coupon rate represents the par rate for a forward starting swap matching the terms of the underlying swap of a swaption that they want to trade, which is then used as the basis to agree on a strike rate and price (premium) the dealer will offer for a swaption defined by certain characteristics. The strike rate may be above or below the par rate for the underlying. The characteristics of the option include payer/receiver, time to maturity and notional amount. The characteristics of the underlying swap include effective date, fixing date, tenor, maturity date, index, fixed leg payment intervals, floating leg payment intervals, fixed leg day count convention, floating leg day count convention, and holiday calendar, among others. The strike rate is expressed in terms of percentage of notional value of the underlying swap, and defines the total annual payments due from fixed leg payer to the fixed leg receiver following option exercise.

In practice, counterparties often first agree on which fixed coupon rate currently reflects the par rate of the underlying forward starting swap, then agree on strike rate, then proceed to negotiate the price (in premium) terms that the option buyer will pay to the option seller based on the strike rate. Alternatively, a trader may have strike in mind and may negotiate the price. The strike rate of the option may be equivalent to the par rate of the underlying swap, or it may be above or below. Options in which the strike rate is equivalent to the par rate of the underlying swap are referred to as ‘at-the-money-forward’. It is common for OTC swaption market participants to speak in terms of the relationship of a strike rate to the par rate of the underlying spot. Because the par rate of the underlying forward starting swap is always moving, the at-the-money strike rate is also always changing. Terms of a swaption trade may call for exchanging premium at the time of the trade (generally referred to as ‘upfront premium’), or exchanging premium at the termination date of the option (generally referred to as ‘deferred premium’).

Historical swaption market convention involves negotiation of the strike in rate terms with minimum increments of one basis point or less (herein referred to as sub-basis point increments), most commonly quarters of a basis point. For example, counterparties agreeing to trade a swaption with financial instruments offered in increments of quarters of a basis point may agree on a strike rate of 2.0000%, 2.0025%, or 2.0050%. Given the maturity of the swaption market and the entrenched convention of trading in strike rates (rate-based strike prices) with the characteristics described above, attempts to promote trading of swaptions with strike prices denominated in anything other than fixed rate will be forced to overcome what will be referred to herein as the preference for rate-based strike prices issue.

While holding open option positions, options traders typically engage in the practice of delta hedging to manage risk. Delta is a measure of the change in value of an option with respect to changes in the value of the underlying. To engage in delta hedging, options traders can buy and sell a variety of financial instruments correlated to the value of the option. Due to the implicitly high correlation with the option, a preferred choice is to buy and sell the underlying itself, provided that sufficient liquidity exists in that financial instrument for it to be an efficient (cost-effective) delta hedging financial instrument. For example, a trader that uses delta hedging to manage risk of a long call option position that matures in April, 2012 for May-delivered Corn Futures will generally buy and sell May Corn Futures multiple times as the value of the futures and options change throughout the holding period.

In choosing which financial instrument to use for delta hedging purposes, traders look for a financial instrument that combines two elements. First, they look for a financial instrument that is an effective hedge, meaning that the value of the financial instrument is highly correlated to the value of the option. Second, they look for a financial instrument that is highly liquid. Delta hedging requires options traders to trade multiple times during the option holding period, and to cross the bid-ask spread of the delta hedge financial instrument each time. Because of this, achieving maximum efficiency (minimizing cost) implies choosing a delta hedge financial instrument with a sufficiently large number of participants willing to trade sufficient sizes of buy and sell orders at bid-ask spreads as narrow as possible.

Options traders are frequently required to make trade-offs between these two considerations in selecting a proper delta hedging financial instrument. For example, the May Corn Future in the example above is the most effective hedge financial instrument. However, the trader may find that a less effective hedge financial instrument, such as the July Corn Future, may be more attractive at certain points in time because it is more highly liquid. The July Corn Future is relatively less effective as a hedge financial instrument because prices of July Corn Future are likely correlated with the May Corn Future, but to a lesser degree than the May Corn Future itself. The ideal financial instrument for delta hedging is one that is both a highly effective hedge and is also highly liquid.

The relative quality of financial instruments available for delta hedging often has a direct impact on the liquidity of options markets themselves. Options products where delta hedging financial instruments are relatively ineffective and/or illiquid suffer from a shortage of available bids and offers in sufficient size and price quality to generate high trading volume, compared with otherwise-equal options with higher quality delta hedging opportunities. The relationship between options liquidity and quality of delta hedging financial instruments is straightforward: Options traders are more willing to engage in the higher risks associated with trading an option in larger size and more efficient prices (narrower bid/ask spread) as the quality increases of financial instruments available for them to manage those risks.

Due to the tradeoff between hedge effectiveness and liquidity, OTC swaptions traders often use spot-starting par swaps to practice delta hedging for swaptions. This is done, even though there are multiple other financial instruments available that would be more effective hedges; each of the alternatives with higher correlations to the value of the option usually has insufficient liquidity to be used as an efficient delta hedge financial instrument.

For example, consider a swaption trader who on 1 May 2012 sells (writes) a receiver option with maturity date 18 Jun. 2012 on an underlying plain-vanilla interest rate swap with effective date 20 Jun. 2012, 10-year tenor, and strike of 2.0025%. The most effective hedge financial instrument available for delta hedging purposes would be a swap with terms that match the underlying swap of the option, including effective date, maturity date and coupon rate. In this example with a one swaption portfolio, the swaption trader would unambiguously prefer to use this swap for delta hedging if sufficient liquidity existed in this swap. Unfortunately, the relative lack of liquidity for this specific financial instrument (or any forward-starting interest rate swap with a specific coupon) strongly incents swaptions traders to use other financial instruments for delta hedging.

Another alternative for delta hedging that is available in this example is a forward-starting swap, aligning with the effective date and maturity date of the underlying swap, but with a coupon value that reflects the par value at the time of the swap trade, which almost certainly will deviate from the strike rate of the swaption. These markets also often lack sufficient liquidity to provide efficient delta hedging—the bid/ask spread of these financial instruments is almost invariably significantly wider than the bid/ask spread for standard maturity spot-starting par swaps. This drives swaptions traders often to use for delta hedging even less effective financial instruments that deviate from the underlying swap in both dates and coupons. Further potential alternatives include spot-starting par swaps, and US Treasury Bonds and Notes.

Furthermore, traders of OTC swaptions using the par coupon trading convention described above naturally accumulate portfolios of multiple options positions that are substantially similar in terms of option expiration date, effective date and tenor of underlying swaps, but with distinct strike rate levels. For example, an options trader may accumulate open positions in three receiver options, each maturing 18 Jun. 2012 for an underlying plain-vanilla interest rate swap with a tenor of ten years, effective date of 20 Jun. 2012, but with three distinct strike rates of 2.0025%, 2.5000%, and 2.6000%. Perfectly effective delta hedging would require the trader to establish positions in three separate underlying swaps, each of which today is relatively illiquid. Here the granularization issue is at play, as the proliferation of fixed rate swaps available for trading makes it unlikely that sufficient liquidity for efficient delta hedging purposes will be generated in any market for a swap with a single specific fixed rate coupon.

These consequences of the granularization issue on delta hedging effectiveness, taken together with the current lack of liquidity in the specific swaps that underlie many swaptions (which forces options traders to use less effective delta hedging financial instruments with more liquidity), comprise what will herein be referred to as the delta hedging liquidity issue, from which many of today's swaptions markets suffer.

All other factors equal, a centrally-cleared swaption that is physically-delivered may be viewed as superior to an otherwise-equivalent option that is cash-settled, due to the reduced costs of liquidating hedge positions upon option expiration. Consider the example upon option exercise of a trader (Trader A) with a position in a physically-delivered, centrally-cleared option and a perfectly-offsetting position in the underlying for delta hedge purposes, versus another trader (Trader B) with an identical position in an otherwise-identical, cash-settled, centrally-cleared option and an identical, perfectly-offsetting position in the underlying for delta hedge purposes. Upon exercise of the options, Trader B will receive or pay cash according to the terms of the option, and must then incur additional costs to liquidate his underlying position, in the form of crossing the bid/ask spread and transaction costs. Trader A, on the other hand, will take or make delivery of the underlying such that his net outstanding position in the underlying will be reduced to zero, as his delivered option and underlying offset his existing position in the underlying. Trader A will not be required to pay any additional costs to liquidate his position.

In addition, calculating the amount of cash to be exchanged between counterparties upon expiration of a cash-settled, centrally-cleared swaption requires the CCP to affix a market value to the underlying financial instrument itself. The market value is based upon the exchange's calculation of the theoretical fair price of the instrument, generally based on a pre-determined formula published by the CCP. Determining liquidation prices based on theoretical calculations implicitly subjects the cash settlement process to increased vulnerability of manipulation from market participants that act to influence the price calculation in their favor. Physically delivered contracts require no such arbitrary liquidation price determination by a CCP, thereby making them less susceptible to manipulation.

While a large proportion of trading of swaps and options on swaps (particularly for interest rate swaps and credit default swaps) has traditionally been uncleared, recently there has been pressure to migrate swaps to central clearing, including mandates set forth in the Dodd-Frank Wall Street Reform and Consumer Protection Act (the “Dodd-Frank Act”) (Pub.L. 111-203, H.R. 4173) signed into law by President Obama on 21 Jul. 2010. As a result of political pressure for greater transparency of uncleared financial instruments, the Dodd-Frank Act was passed into law in the wake of the 2008/2009 financial crisis. During the 2008/2009 financial crisis, many participants in uncleared financial instruments faced counterparties that were unable to meet their obligations. Market forces, including credit concerns related to European sovereign debt, have caused many market participants to pursue proactively clearing of interest rate swaps. Additionally, there are certain elements of Basel III that provide market participants with economic incentives to clear interest rate swaps. Basel III is a global regulatory standard on bank capital adequacy, stress testing and market liquidity risk agreed upon by the members of the Basel Committee on Banking Supervision in 2010-11. The Basel Committee on Banking Supervision is a committee of banking supervisory authorities that was established by the central bank governors of Belgium, Canada, France, Germany, Italy, Japan, the Netherlands, Sweden, the United Kingdom, and the United States, in 1974.

OTC interest rate swaptions experienced strong growth in trading volumes in the years leading up to 2008; however, anecdotal evidence indicates that traded volumes dropped dramatically in 2008 and have yet to grow back to pre-2008 levels.

As of April 2012, major derivatives clearing houses CME Clearing and London Clearing House (LCH) did not provide CCP services for options on interest rate swaps or options on credit default swaps; however, both CME Clearing and LCH have publicly announced that CCP support for options on these swaps is in their upcoming new offerings. http://www.thejavelin.com/recent-press/swapclear-cme-andjavelin-on-swap-clearing (accessed 11 Apr. 2012). A centrally-cleared version of an OTC swaption is likely to be viewed as superior to an uncleared OTC swaption by many market participants, especially traders who are held back from trading uncleared OTC swaptions by concerns about counterparty credit risk and/or opaqueness in the daily mark-to-market pricing process for uncleared trades. To the extent that a CCP mimics the existing OTC interest rate swaption conventions allowing for trading of par rate options negotiated in rates of minimum strike rate increments at or near one-quarter of a basis point, and with each strike rate delivering into a distinct swap with a different coupon rate, a cleared option with physical delivery will continue to suffer from the granularization issue and the delta hedging liquidity issue. If the majority of interest rate swaps become cleared, it will be important (and perhaps mandated) for market participants to also clear swaptions in order reduce counterparty risk and to maximize economic efficiency associated with posting initial margins.

As described above, existing swap derivatives financial instruments carry certain advantages and disadvantages in terms of structure. Overcoming the trade-offs that have traditionally been inherent in trading par swaps, off-market swaps, and futures in this new, government regulated environment has proven to be a significant challenge. At first glance, it would seem that the solution to these issues could all be addressed through the creation of a future for forward-starting swaps in a standardized coupon. By listing futures that are forward-starting and with a standardized coupon, the effects of the granularization issue are mitigated. And futures need not impose upfront payments, thus avoiding the upfront payment issue.

The Chicago Board of Trade's 10-Year Interest Rate Swap Futures attempts to list futures products with the economics of forward-starting swaps based on a standardize coupon. See http://www.cmegroup.com/trading/interest-rates/files/IR145_SwapFC_lo-res_web.pdf (accessed 17 May 2011). However, after multiple years of existence, these 10-Year Interest Rate Swap Futures trade at daily volume levels that are low relative to the volume of the interest rate swaps market, suggesting that market has failed to adopt them as true substitutes for interest rate swaps. Open interest for this future, as of 17 May 2011, was reported by CME Group (http://www.cmegroup.com/daily_bulletin/preliminary_voi/VOIREPORT.pdf, accessed 17 May 2011) to be 11,694 futures, which equates to $1.69 billion of notional value, compared to $364 trillion dollars of notional value of open interest for interest rate derivatives that ISDA estimated in March, 2011 (http://online.wsj.com/article/BT-CO-20110329-709826.html, accessed 17 May 2011), or 0.0003%.

Assessing the potential success or even explaining the lack of success of futures is not straightforward, as a thriving futures market requires the confluence of a large number of factors, such as futures design, distribution, technology, liquidity, and macroeconomic forces. Issues related to the design of the CBOT Swap Future that may contribute to its lack of commercial success include, the CBOT Swap Future only allows traders to transact a single coupon rate, imposing rigid standardization to minimize the granularization issue. The rate was 6.0% for the CBOT Swap Futures that expired from inception until December 2009, and has been set by the exchange at 4.0% since that time. In addition, the CBOT Swap Future is “traded in price and quoted in points”, as per the CBOT web site, rather than the par coupon or NPV protocols more familiar to the swap market. http://www.cmegroup.com/trading/interest-rates/files/IR145_SwapFC_lo-res_web.pdf (accessed 17 May 2011).

Another issue related to the design of the CBOT Swap Future that may contribute to its lack of commercial success is, the CBOT Swap Future does not seek to mimic the economics of a swap over the entire maturity of the swap: the CBOT Swap Future expires and is cash-settled at the conclusion of the forward-period of the swap. For example, the September 2011 CBOT 10-year Interest Rate Swap Future expires 19 Sep. 2011, at which point the position is settled by the clearinghouse and open interest ceases to exist. A comparable OTC interest rate swap implies that the forward-period ends in September 2011, but the swap itself does not mature until September 2021. In addition, the CBOT Swap Future uses simple present value analysis, rather than adhering to swap convention of discounting cash flows at LIBOR or overnight indexed swap (OIS) rates.

Thus, a new swaption, and the electronic clearing and settling of such swaption, based on an underlying with sufficient liquidity to overcome the delta hedging liquidity issue would be desirable. In addition, a new swaption, and the electronic clearing and settling of such swaption, offering a limited quantity of standardized strike rate levels would mitigate the granularization issue. In addition, a new swaption, and the electronic clearing and settling of such swaption, addressing the preference for rate-based strike prices issue would present a better alternative than currently available swaption financial instruments. Providing independent central counter-party clearing and settlement services for a new swaption with these characteristics would also mitigate two other drawbacks of the current OTC market: counterparty credit risk and lack of independent valuation of swaption portfolios. Additionally, a new swaption, and the electronic clearing and settling of such swaption, that is physically-delivered upon exercise would potentially be viewed as more desirable than a cash-settled swaption due to the additional costs of liquidating delta hedge positions typically associated with trading cash-settled options.

### SUMMARY OF THE INVENTION

In one aspect, a flexible-rate option and method of trading in accordance with the principles of the present invention allows for trading of a swaption (option on swap or option on swap future) product that mitigates the granularization issue that affects traditional OTC swaptions. In one aspect, a flexible-rate option and method of trading in accordance with the principles of the present invention addresses the preference for rate-based strike prices issue. In one aspect, a flexible-rate option and method of trading in accordance with the principles of the present invention has a greater opportunity to overcome the delta hedging liquidity issue by providing the market a common underlying across multiple strike rate levels. This may further enhance liquidity in these underlying benchmark financial instruments, and thus reinforce their attractiveness as desirable trading vehicles for delta hedging.

In accordance with the principles of the present invention, a flexible-rate option and method of electronic trading are provided. The flexible-rate option includes a negotiable premium and a corresponding rate-based strike rate. At least one discount curve, and potentially also a forward curve are determined. An adjustment factor for the financial instrument is determined. The curve or curves are used to determine the adjustment factor to determine the adjusted exercise price of an underlying with a standardized coupon as the present value difference between the delivered financial instrument with a fixed rate and a swap with the strike rate, at or near the time of option exercise. Thus, the flexible-rate option of the present invention provides for a financial instrument with rate-based strike prices (strike rates) to be exercised into an underlying position in an equivalent standardized coupon financial instrument with similar terms as the underlying swap that is defined by the option terms, with a potentially different fixed rate and an exercise price.

This Summary introduces concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow-chart setting forth an example for determining the adjusted exercise price of an interest rate swap delivered upon exercise of an option, using an example adjustment factor.

FIG. 2 is a flow-chart setting forth an example for determining the adjusted exercise price of an interest rate swap delivered upon exercise of an option, using another example adjustment factor.

FIG. 3 is a non-limiting example of a hardware infrastructure that can be used to run a system that implements electronic trading of a flexible-rate financial option of the present invention.

### DETAILED DESCRIPTION OF A PREFERRED EMBODIMENT

While an exemplary embodiment of the invention illustrated and described herein is planned to be listed for trading on Eris Exchange, it will be appreciated that the present invention is not so limited and can be traded on other exchanges or trading platforms, regardless of whether located in the United States or abroad, traded through a private negotiation, traded in currencies other than United States dollars or traded as a futures option or as a cleared swap option or other type of financial instrument, based on financial instruments indexed to indices other than LIBOR, traded with premiums that are paid up-front or deferred. When used herein, the terms exchange and trading platform refer broadly to a marketplace in which securities, commodities, derivatives and other financial instruments are traded, and includes but is not necessarily limited to designated contract markets, exempt boards of trade, designated clearing organizations, securities exchanges, swap execution facilities, electronic communications networks, and the like.

One potential method to improve the volume and liquidity in the existing swaption market would be to convince traders to transact options in standardized fixed-rate strike levels. For example, instead of trading otherwise identical swaptions in flexible par rate strikes, a centralized marketplace or exchange could offer a swap with a limited set of standard strike rate levels. This standardization would mitigate the granularization issue by concentrating options trading into a limited number of strike rate levels, but would unfortunately still deliver into distinct financial instruments upon the exercise of options with distinct strike rates. This standardization would also likely fail to overcome the delta hedging liquidity issue unless the underlying swaps carrying the standardized fixed rate coupon value itself were enhanced in ways that generated additional liquidity.

In October 2011, Eris Exchange featured for trading forward-starting Eris IR Swap Futures with standardized dates based on the International Monetary Market (IMM) calendar, and standardized, fixed rate coupons. For example, in April 2012 the so-called Eris Exchange IMM-dated benchmark futures included the following three plain-vanilla interest rate swap futures, with price negotiated in NPV:
June IMM 2-year: 2 year tenor, effective date Jun. 20, 2012, maturity date Jun. 20, 2014, coupon of 0.500%.
June IMM 5-year: 5 year tenor, effective date Jun. 20, 2012, maturity date Jun. 20, 2017, coupon of 1.250%.
June IMM 10-year: 10 year tenor, effective date Jun. 20, 2012, maturity date Jun. 20, 2027, coupon of 2.000%.

As of April 2012, Eris Exchange IMM-dated benchmark futures have attracted active participation in the form of continuous quoting of bids and offers from multiple liquidity providers, in notional values that range from $50,000,000 to $300,000,000 during most trading days. Volumes are greater than $225,000,000 in notional value. This relatively small success in developing an initial foundation of liquidity is noteworthy in that these futures attempt to concentrate liquidity away from par rate-based swap derivative trading and overcome the preference for par swaps issue.

If the Eris Exchange IMM-dated benchmark futures increase in liquidity through some combination of increased amount of participants, larger sizes of bids and offers, tighter bid ask spreads, and more trading and open interest, the Eris Exchange IMM-dated benchmark futures would become a viable alternative as an underlying of a swaption that overcomes the delta hedging liquidity issue and the granularization issue. In listing an option on a liquid June IMM 2-year interest rate swap future, Eris Exchange could choose to list a single strike of ‘par’, or could list multiple strike rates denominated in NPV (for example, NPV strike rates could be −$10,000, −$5000, $0, $5000, $10000). Either construction, however, fails to mitigate the preference for rate-based strike prices issue. Setting strikes in NPV or price terms changes the risk that is being traded given the non-linear relationship between rates and NPV levels over time.

In 2009, in an attempt to attract trading volume from the OTC swaption market, CBOT listed for trading options on the CBOT Swap Future. These futures attempted to overcome the delta hedging liquidity issue by using the CBOT Swap Future products as underlying financial instruments. The financial instrument allows traders to transact at strike levels denominated in futures price terms, indexed to 100. As of April 2012, options on CBOT swap futures remain listed and available for trading, but no options on CBOT swap futures have traded since introduction. http://www.cmegroup.com/trading/interest-rates/options-open-interest/main.html (accessed 11 Apr. 2012). Once again, issues related to the design of the Option on CBOT Swap Future that may contribute to its lack of commercial success include the lack of viability of the design of the underlying swap future, lack of liquidity of the underlying swap future and lack of mitigating the preference for rate-based strike prices issue.

What is thus desirable would be to combine the advantages of an option like the potential Eris Exchange option described above, with a limited number of strike rate levels where multiple strike rates deliver into a common underlying financial instrument upon exercise, thereby substantially mitigating the granularization issue and avoiding the delta hedging liquidity issue, but in a form that also overcomes the preference for rate-based strike prices issue.

The present invention provides a mechanism whereby a financial option with a rate-based strike price can be exercised into a physically-delivered underlying position in a financial instrument with all of the same terms other than a potentially different fixed rate. The fixed rate of the delivered underlying will often be different from the negotiated strike rate, and an exercise price will be determined accordingly to account for the present value difference between a swap with the fixed rate and a swap with the negotiated strike rate. In accordance with the principles of the present invention, a flexible-rate, financial option and method of electronic trading that exercise into a standardized coupon financial instrument at an exercise price and method of trading are provided. This invention allows for delivery of an underlying that has one term that differs (the fixed rate) from the underlying par financial instrument that would have been delivered (i.e., fixed rate equals the option strike rate) by assigning an exercise price so that the two financial instruments are equivalent and have equivalent value. When used herein, the term equivalent means nearly equal in amount, value, measure, force, effect, significance, etc. and encompasses a financial instrument with a different coupon rate, at an adjusted price, having nearly-equivalent but economically satisfactory position. When used in conjunction with an option such as, for example, the option on Eris Exchange IMM-dated benchmark futures described above, employing the present invention allows the listing of rate-based strike prices for options. Such options would be executed at multiple strike rate levels but delivered upon exercise into a common underlying financial instrument with a single coupon rate—by determining appropriate exercise prices according to the methods described below. The resulting option mitigates the granularization issue and delta hedging liquidity issue through delivery of options at various strike rate levels into a single underlying financial instrument with a single fixed rate. This addresses the preference for rate-based strike prices issue through its use of the present invention. This swaption also accrues the benefits of physical delivery in the form of providing the opportunity to reduce the cost of liquidating delta hedge positions that is typically incurred when trading cash-settled swaptions.

Initially, a general example for determining the exercise price for the underlying is described. Curve input data such as for example deposit rates, swap rates, spreads, Treasury rates, risk free lending rates, forward rate agreement rates, interest rate futures prices, etc. are input into a curve constructor which generates a discount curve and a forward curve. The net present value (NPV) of the plain-vanilla interest rate swap can be written as the difference between the present value of fixed coupon payments and floating coupon payments. The price for a swap with a fixed coupon c is:

$$NPV ( c , t ) = c {\sum }_{i = 1}^{N} {τ}_{c , i} DF ( t , {T}_{c , i} ) - {\sum }_{i = 1}^{N} L ( t , {T}_{l , i} ) {τ}_{l , i} DF ( t , {T}_{l , i} ) \qquad Equation 1$$

where,
L(t,T_{l,i}) is the forward rate at l, relevant to the floating payment at T_{l,i};
DF(t,s) is the discount factor from t to s, t≦s; and
τ_{c,i}τ_{l,i}, are the year fractions of the accrual period for fixed and floating payments respectively.
   Equation 1 represents the generic formula for valuing an interest rate swap. Extensions of this formula can be used to determine the appropriate exercise prices that compensate for the value differential of two swaps with all of the same terms other than the fixed rate. The method to calculate the exercise price utilizes quantities commonly referred to as PV01 and DV01.

The discount rates and forward rates may or may not be derived from the same yield curve. For example, when modeling plain-vanilla interest rate swaps before 2007, the market practice was to use a LIBOR curve to derive both rates; after the financial crisis, the growing consensus has migrated to use of the OIS curve to derive discount rates, and a LIBOR curve to calculate the forward rates. Various assumptions and curve construction methodology do not affect the application of the present invention.

In accordance with the principles of the present invention, at or near the time of exercise of the option, the discount curve can be used to determine the proper exercise price at which the underlying financial instrument will be delivered upon option exercise, using for example Equation 3 below. This addresses the present value difference between the delivered financial instrument with the fixed rate and one with the option strike rate.

Denoting the summation

$${\sum }_{i = 1}^{N} {τ}_{c , i} DF ( t , {T}_{c , i} )$$

by A(t), A(t) is called the annuity of the swap, also known as present value of a basis point (PV01), and the PV01 is also referred to as the ‘value of a fixed rate basis point’ and it represents the change in the value of a swap for a one basis point change in the fixed rate. The PV01 is determined by the discount (funding) curve. Note that the PV01 will be the same for all swaps with the same terms other than the fixed rate. For two swaps that have the same characteristics other than fixed rate—floating leg index, start date, payment schedules, day count, and holiday conventions—the difference in NPV is:

NPV(c₁,t)−NPV(c₂,t)=(c₂−c₂)A(t) Equation 2

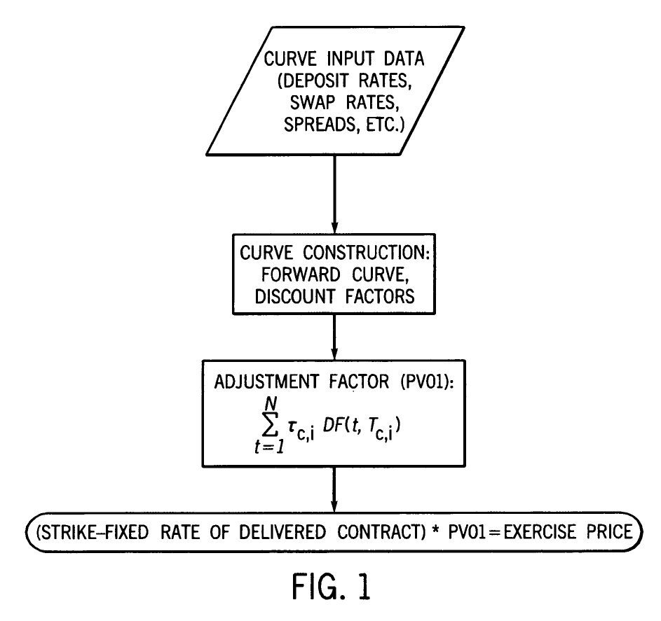

Based on this observation, an embodiment of a flexible-rate financial option and method of trading can be provided. Referring to FIG. 1, a flow-chart is seen setting forth an example that illustrates how to determine the exercise price for an underlying that is delivered as the result of an option position using PV01 as an adjustment factor. Let c₂ be a fixed rate for a swap with a fixed rate that matches the option strike rate. At any point following the consummation of the trade through agreement of price in premium terms, and subsequent exercise of the option into its underlying swap, a swap with a given coupon c₁ can be assigned an exercise price equal to the difference in present values of a swap with a coupon c₂ and a swap with a coupon c₁ This exercise price is determined as follows:

=Exercise Price. Equation 3

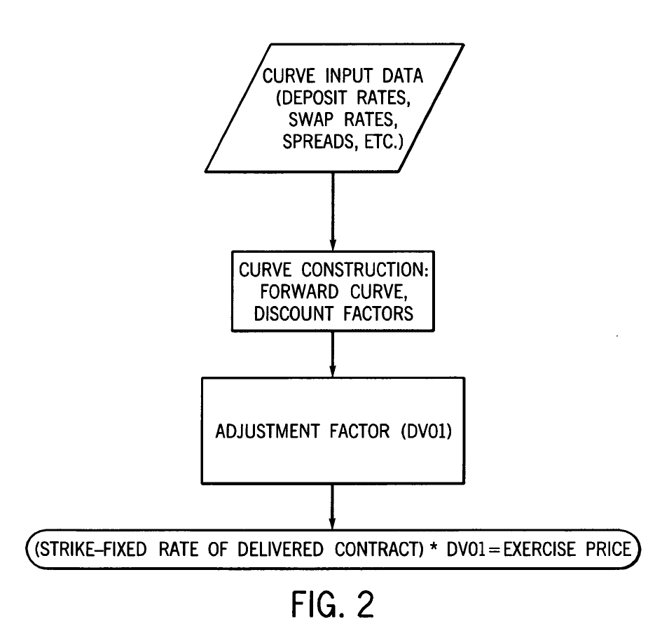

In another embodiment of the present invention, the sensitivity of a swap with respect to the change in the par swap rate, can be used to compute the exercise price, as shown in FIG. 2. The sensitivity is often referred to as “DV01”. The DV01 represents the change in the value of a swap for a one basis point parallel shift in the swap curve. This is also referred to as the ‘curve ‘01’. Different methodologies are employed in the market to determine DV01s. This application is intended to include all variants. Note that the DV01 of swaps with the same terms other than fixed rate will have different DV01 levels. In practice, DV01 and PV01 are often used interchangeably, and their values are close for par swaps. Therefore, the exercise price can be determined or approximated by a similar process to the previous embodiment other than the use of the DV01 rather than PV01:

Equation 4

The NPV of the basis swap can be written as the difference between the present value of two legs of floating coupon payments. The price for a swap with a fixed coupon is:

Equation 5

where,
,) )are the rates at determined by two forward curves, relevant to the floating payments at respectively;
is the discount factor from t to s , t<s; and
are the year fractions of the accrual periods of the two floating payments respectively.

An option on a basis swap can be constructed such that a buyer has the right to pay one of the floating legs with a pre-defined fixed spread over that leg. The option also can be constructed so that the purchaser has the right to receive one of the floating legs with a pre-defined fixed spread over that leg. The pre-determined fixed spread over one of the floating legs is the strike of the option.

Delivery would occur in an underlying basis swap with a fixed spread over one of the floating legs which is equivalent to the option strike. The exercise price is effectively 0 as this instrument is delivered at par.

The present invention provides a mechanism whereby an option on a basis swap with a spread based strike can be exercised into a basis swap with a potentially different spread with an appropriate exercise price. Similar to the case of swaptions, this mechanism mitigates the granularization issue and delta hedging liquidity issue through delivery of options at various strike spread level into a single underlying basis swap with a single fixed spread. An option exercise price is determined by using the present value difference between the basis swap with a certain strike spread and the delivered basis swap that may have a different fixed spread.

For two basis swaps that have the same characteristics—floating leg indices, start date, payment schedules, day count, and holiday conventions—except for the fixed spread, denoted by c₁ and c₂ respectively, the difference in NPV is:

NPV(c₁,t)−NPV(c₂,t)=(c₁−c₂)Σᵢ₌₁^{N}τ_{1,i}DF(t,T_{1,i}) Equation 6

Denoting the adjustment factorA(t)=Σᵢ₌₁^{N}τ_{1,i}DF(t,T_{1,i}), which is also called the PV01 of the swap, Equation 6 can be used to determine the appropriate exercise price to account for the present value difference between the delivered basis swap with spread c₁ and a basis swap with the strike spread c₂. Similar to the case of a swaption, the exercise price can be determined using either the PV01 or the DV01 as the adjustment factor.

Generally, the profit and loss of a cleared swap comes only from the price change, and, thus, modifying the price process by adding or subtracting a constant does not affect the nature of the swap. Likewise, in another embodiment in accordance with the present invention, the exercise price can be adjusted by the same constant.

Counterparties negotiate the price in premium terms for an option product with a specific strike rate. Multiple strike rate levels for trading are available, each of which results in delivery of a common underlying financial instrument. There is an analogous receiver option for each payer option. Upon exercise of the option, the exercise price of the delivered financial instrument is determined by the present value difference between the delivered financial instrument with the fixed rate and the financial instrument with the option strike rate in accordance with either Equation 3 or 4 as described above. A preferred implementation is for the price adjustment to occur upon exercise of option; while this adjustment can be performed at any time after the trade is consummated, however, adjustment immediately prior to or concurrent with exercise is currently believed to represent increased commercial viability.

Although the products to be listed by Eris Exchange in accordance with the principles of the present invention will likely have effective dates on quarterly International Monetary Market (IMM) dates, other embodiments are possible. The present invention can be used with American-style options (options that may be exercised at any time on or before the expiry date) or European-style options (options that may only be exercised at the expiry date of the options).

The following are non-limiting examples of exercising a flexible-rate option into a standardized coupon financial instrument with an exercise price. Unless specified otherwise, the exercise price is equal to the present value difference between a swap with the strike rate and the delivered swap with a different fixed rate. All exercise prices are determined from the perspective of the fixed rate payer.

### EXAMPLE 1

This example shows that a flexible-rate option can be exercised into a standardized coupon financial instrument using PV01 to determine the exercise price, as described above in Equation 3. This example is a payer option.

Consider a forward starting 2-year LIBOR interest rate swap with notional amount of $1,000,000. Assume that the discounting curve is an OIS curve, and the forward curve is a LIBOR curve, though construction of a forward curve may not be necessary for the application of the invention in this example. A set of LIBOR swap rates, Eurodollar rates, forward rate agreement rates, LIBOR rates, Treasury rates and swap spreads, etc. are used to construct the OIS curve and LIBOR curve. A list for multiple options based on this underlying swap with a common coupon value, might be:

| Listed Payer (Receiver) Option for | |
|---|---|
| Trading Today (price negotiated in | Underlying Financial Instrument |
| premium) | Delivered Upon Exercise |
| Right to pay (receive) fixed at a rate of | Jun. 20, 2012 Effective Date, |
| 1.750% on a par financial instrument | 2 year tenor, 2.000% coupon, |
| of 2 years tenor, option expiration | invention-determined exercise price |
| Jun. 15, 2012 | |
| Right to pay (receive) fixed at a rate of | Jun. 20, 2012 Effective Date, |
| 1.875% on a par financial instrument | 2 year tenor, 2.000% coupon, |
| of 2 years tenor, option expiration | invention-determined exercise price |
| Jun. 15, 2012 | |
| Right to pay (receive) fixed at a rate of | Jun. 20, 2012 Effective Date, |
| 2.000% on a par financial instrument | 2 year tenor, 2.000% coupon, |
| of 2 years tenor, option expiration | invention-determined exercise price |
| Jun. 15, 2012 | |
| Right to pay (receive) fixed at a rate of | Jun. 20, 2012 Effective Date, |
| 2.250% on a par financial instrument | 2 year tenor, 2.000% coupon, |
| of 2 years tenor, option expiration | invention-determined exercise price |
| Jun. 15, 2012 | |
| Right to pay (receive) fixed at a rate of | Jun. 20, 2012 Effective Date, |
| 2.500% on a par financial instrument | 2 year tenor, 2.000% coupon, |
| of 2 years tenor, option expiration | invention-determined exercise price |
| Jun. 15, 2012 | |

In this example, counterparties negotiate the price (in premium terms) for a payer option product with a specific strike rate of 2.250%. The specification of the option at the time of the trade states that the option is an option on an underlying swap with a coupon of 2.000%. The underlying benchmark financial instrument is a two-year June IMM dated financial instrument with an effective date of Jun. 20, 2012 and fixed leg of 2.000%. The option has European-style exercise.

On the date that the option expires (Jun. 15, 2012), at the time the settlement (mark-to-market) prices are assigned to outstanding Eris financial instruments, the underlying PV01 (change in value for one basis point change in the fixed leg) is $924. The par rate at close of a financial instrument with similar terms to the June IMM dated two-year swap on Jun. 15, 2012 is 2.400%. The option holder elects to exercise one payer option with a strike rate of 2.250% because the option is in-the-money (that is, par rate for the financial instrument is above the strike rate). Each counterparty receives (is delivered) a position (option buyer becomes long, option seller becomes short) in one underlying (Jun. 20, 2012 Effective Date, 2 year tenor, 2.000% coupon) in advance of Exchange opening on Jun. 18, 2012 at an invention-determined price of $23,100. This exercise price is:

(Strike rate−fixed rate of underlying future)*100*PV01 of underlying financial instrument=Price of delivered financial instrument=25 bps*924

The option seller is now short (receives the fixed leg) the same financial instrument at the same price of $23,100. The fair market value of the underlying with a fixed rate of 2.000% is approximately $36,960 which is the present value difference between the par rate at exercise of 2.400% and the fixed rate of the underlying of 2.000% (924*40 bps). As a result, the option buyer has unrealized gains of approximately $13,860 which is the present value difference between the strike of 2.250% and the par rate of 2.400% (924*15 bps). The option seller has an equivalent unrealized loss of the same amount. This is equivalent to the unrealized gain that the trader would have had (ignoring friction costs and other inefficiencies associated with current OTC swaption protocols) if delivery occurred in a financial instrument with a fixed rate equal to the option strike rate.

### EXAMPLE 2

This example shows that a flexible-rate option can be exercised into a standardized coupon financial instrument using PV01 as the adjustment factor, as described above in Equation 3, this time for a receiver option.

Consider a forward starting 10-year LIBOR interest rate swap with notional amount of $1,000,000. Assume that the discounting curve is an OIS curve, and the forward curve is a LIBOR curve, though construction of a forward curve may not be necessary for the application of the invention in this example. A set of LIBOR swap rates, Eurodollar rates, forward rate agreement rates, LIBOR rates, Treasury rates and swap spreads, etc. are used to construct the OIS curve and LIBOR curve. A list for multiple options based on this underlying swap with a common coupon value, might be:

| Listed Payer (Receiver) Option for | |
|---|---|
| Trading Today (price negotiated in | Underlying Financial Instrument |
| premium) | Delivered Upon Exercise |
| Right to pay (receive) fixed at a rate of | Sep. 19, 2012 Effective Date, |
| 3.300% on a par financial instrument | 10 year tenor, 3.500% coupon, |
| of 10 years tenor, option expiration | invention-determined exercise price |
| Sep. 14, 2012 | |
| Right to pay (receive) fixed at a rate of | Sep. 19, 2012 Effective Date, |
| 3.400% on a par financial instrument | 10 year tenor, 3.500% coupon, |
| of 10 years tenor, option expiration | invention-determined exercise price |
| Sep. 14, 2012 | |
| Right to pay (receive) fixed at a rate of | Sep. 19, 2012 Effective Date, |
| 3.500% on a par financial instrument | 10 year tenor,3.500% coupon, |
| of 10 years tenor, option expiration | invention-determined exercise price |
| Sep. 14, 2012 | |
| Right to pay (receive) fixed at a rate of | Sep. 19, 2012 Effective Date, |
| 3.600% on a par financial instrument | 10 year tenor,3.500% coupon, |
| of 10 years tenor, option expiration | invention-determined exercise price |
| Sep. 14,2012 | |
| Right to pay (receive) fixed at a rate of | Sep. 19,2012 Effective Date, |
| 3.700% on a par financial instrument | 10 year tenor, 3.500% coupon, |
| of 10 years tenor, option expiration | invention-determined exercise price |
| Sep. 14, 2012 | |

In this example, counterparties negotiate the price (in premium terms) for a receiver option product with a strike rate of 3.600%. The specification of the option at the time of the trade states that the option is an option on an underlying swap with a coupon of 3.500%. The underlying benchmark financial instrument is a ten-year September IMM dated financial instrument with an effective date of Sep. 19, 2012 and fixed leg of 3.500%. The option has European-style exercise.

On the date that the option expires (Sep. 14, 2012), at the time the settlement (mark-to-market) price is assigned to all outstanding Eris financial instruments, the underlying PV01 (change in value for 1 basis point (bp) change in the fixed leg) is $1231. The par rate at close of a financial instrument with similar terms to the September IMM dated ten-year swap on Sep. 14, 2012 is 3.551%. The option buyer elects to exercise one receiver option with a strike rate of 3.600%. Each counterparty receives (is delivered) a position (option buyer becomes long, option seller becomes short) in one underlying (Sep. 19, 2012 Effective Date, 10 year tenor, 3.500% coupon) in advance of Exchange opening on Sep. 16, 2012 at invention-determined price of $12,310. This exercise price is:

(Strike rate−fixed rate of underlying future)*100*PV01 of underlying financial instrument=Price of delivered financial instrument=10 bps*1231

The option buyer now has a short position (receives the fixed leg) in the same underlying at a price of $12,310. The fair market value of the underlying with a fixed rate of 3.500% is approximately $6,278 which is the present value difference between the par rate at exercise of 3.551% and the fixed rate of the underlying of 3.500% (1231*5.1 bps). As a result, the option buyer has unrealized gains of approximately $6,032 which is the present value difference between the strike of 3.600% and the par rate of 3.551% (1231*4.9 bps). The option seller has an equivalent unrealized loss of the same amount. This can also be determined by comparing the fair market value of the underlying ($6,278) to the delivered level ($12,310). This is equivalent to the unrealized gain that the trader would have had (ignoring friction costs and other inefficiencies associated with current OTC swaption protocols) if delivery occurred in a financial instrument with a fixed rate equal to the option strike.

### EXAMPLE 3

This example shows that a flexible-rate option can be exercised into a standardized coupon financial instrument using DV01 as an adjustment factor consistent with Equation 4, this time for a receiver option.

Consider a forward starting 10-year LIBOR interest rate swap with notional amount of $1,000,000. Assume that the discounting curve is an OIS curve, and the forward curve is a LIBOR curve. A set of LIBOR swap rates, Eurodollar rates, forward rate agreement rates, LIBOR rates, Treasury rates and swap spreads, etc. are used to construct the OIS curve and LIBOR curve. A list for multiple options based on this underlying swap with a common coupon value, might be:

| Listed Payer (Receiver) Option for | |
|---|---|
| Trading Today (price negotiated in | Underlying Financial Instrument |
| premium) | Delivered Upon Exercise |
| Right to pay (receive) fixed at a rate of | Sep. 19, 2012 Effective Date, |
| 3.300% on a par financial instrument | 10 year tenor, 3.500% coupon, |
| of 10 years tenor, option expiration | invention-determined exercise price |
| Sep. 14, 2012 | |
| Right to pay (receive) fixed at a rate of | Sep. 19, 2012 Effective Date, |
| 3.400% on a par financial instrument | 10 year tenor, 3.500% coupon, |
| of 10 years tenor, option expiration | invention-determined exercise price |
| Sep. 14, 2012 | |
| Right to pay (receive) fixed at a rate of | Sep. 19, 2012 Effective Date, |
| 3.500% on a par financial instrument | 3.500% coupon, |
| of 10 years tenor, option expiration | invention-determined exercise price |
| Sep. 14, 2012 | |
| Right to pay (receive) fixed at a rate of | Sep. 19, 2012 Effective Date, |
| 3.600% on a par financial instrument | 10 year tenor, 3.500% coupon, |
| of 10 years tenor, option expiration | invention-determined exercise price |
| Sep. 14, 2012 | |
| Right to pay (receive) fixed at a rate of | Sep. 19, 2012 Effective Date, |
| 3.700% on a par financial instrument | 10 year tenor, 3.500% coupon, |
| of 10 years tenor, option expiration | invention-determined exercise price |
| Sep. 14, 2012 | |

On the date that the option expires (Sep. 14, 2012), at the time the settlement (mark-to-market) price is assigned to all outstanding Eris financial instruments, the underlying DV01 (change in value of the underlying for a 1 basis point parallel shift in the swap curve is) is $1,350. The par rate at close of a financial instrument with similar terms as the September IMM dated ten-year swap on Sep. 14, 2012 is 3.551%. The option buyer elects to exercise one receiver option with a strike rate of 3.600%. Each counterparty receives (is delivered) a position (option buyer becomes long, option seller becomes short) in one underlying (Sep. 19, 2012 Effective Date, 10 year tenor, 3.500% coupon) in advance of Exchange opening on Sep. 16, 2012 at invention-determined price of $13,500. This exercise price is:

(Strike rate−fixed rate of underlying future)*100*DV01 of underlying financial instrument=Price of the delivered financial instrument=10 bps*1,350

The option buyer now has a short position (receives the fixed leg) in the same underlying at a price of $13,500. The fair market value of the underlying with a fixed rate of 3.500% is approximately $6,885 which is the present value difference between the par rate at exercise of 3.551% and the fixed rate of the underlying of 3.500% (1,350*5.1 bps).

As a result, the option buyer has unrealized gains of approximately $6,615 which is the present value difference between the strike of 3.600% and the par rate of 3.551% (1,350*4.9 bps). The option seller has an equivalent unrealized loss of the same amount. This can also be determined by comparing the fair market value of the underlying ($6,885) to the delivered level ($13,500). This is equivalent to the unrealized gain that the trader would have had (ignoring friction costs and other inefficiencies associated with current OTC swaption protocols) if delivery occurred in a financial instrument with a fixed rate equal to the option strike.

Again, the foregoing are non-limiting examples of exercising a flexible-rate option into a standardized financial instrument with a fixed rate that may differ from the option strike, and with an exercise price.

According to the principles of the present invention, in order to publish daily and terminal settlement values a clearinghouse, exchange, swap execution facility, futures commission merchant or other market participant may use computers with software specifically designed for this purpose. The computation of the exercise price in accordance with the present invention is iterative and complex, and special software is required for this purpose. This software may be linked to a centralized marketplace via data lines, networks or the Internet, so that the prices are published in a seamless manner. The clearinghouse may store the daily prices for each financial instrument in existence at any given moment in a database that can be electronically published to the marketplace.

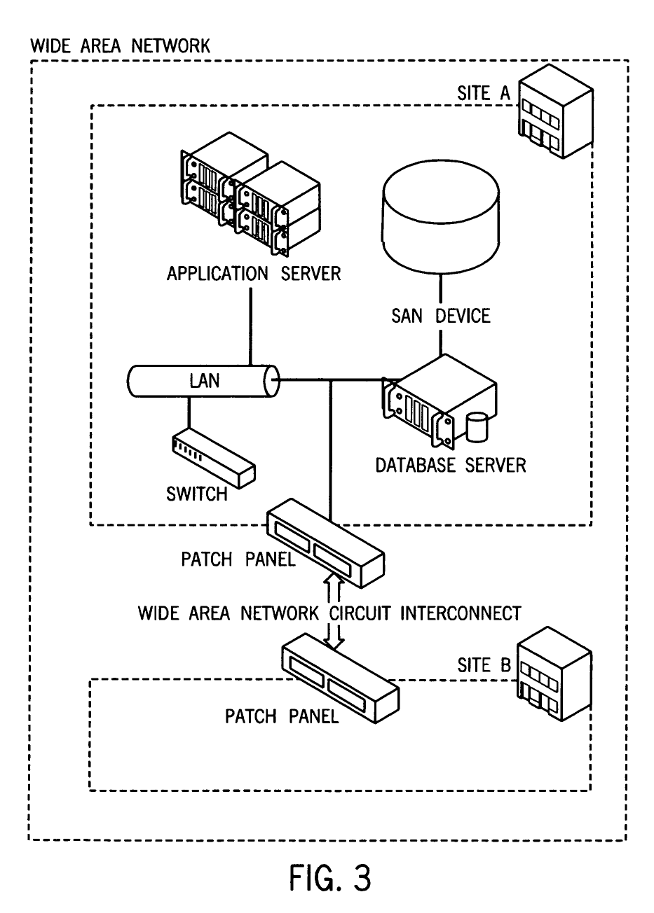

Referring now to FIG. 3, a non-limiting example of a high-level hardware implementation can used to run a system of the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard.

While the invention has been described with specific embodiments, other alternatives, modifications, and variations will be apparent to those skilled in the art. For example, the option could be converted upon execution to an adjusted option with a different underlying and strike rate, instead of waiting until exercise to perform the conversion. Accordingly, it will be intended to include all such alternatives, modifications and variations set forth within the spirit and scope of the appended claims.

What is claimed is:

1. A general-purpose digital computer programmed to carry out a series of steps, the series of steps to electronically clear and settle a flexible-rate financial option comprising:
receiving a premium and a corresponding rate-based strike rate negotiated between two parties;
determining at least one discount curve representative of funding cost of market participants;
based on the at least one discount curve, determining an adjustment factor;
utilizing the adjustment factor to determine an exercise price of an underlying with a standardized coupon at or near the time of expiration;
whereby a financial option with rate-based strike rate and premium terms can be exercised into an underlying position in an equivalent standardized coupon financial instrument with a potentially different fixed rate and an exercise price.

2. The steps of claim 1 further comprising determining at least one forward curve and at least one discount curve consistent with the negotiated coupon.

3. The steps of claim 1 further comprising determining the exercise price of the underlying with a standardized coupon as the present value difference between the delivered financial instrument with a fixed rate and a swap with the strike rate, at or near the time of option exercise.

4. The steps of claim 3 further comprising determining the exercise price of the underlying with a standardized coupon as the present value difference between the delivered financial instrument with a fixed rate and a swap with the strike rate utilizing:
$$( {c}_{2} - {c}_{1} ) {\sum }_{i = 1}^{N} {τ}_{c , i} DF ( t , {T}_{c , i} )$$
where,
c₁ is a fixed coupon;
c₂ is a fixed rate for a swap with a fixed rate that matches the option strike rate;
τ_{c,i} is the year fraction of the accrual period for fixed payments; and
DF(t,T_{c,i}) is the discount factor from t to T_{c,i}.

5. The steps of claim 3 further comprising determining the exercise price of the underlying with a standardized coupon as the present value difference between the delivered financial instrument with a fixed rate and a swap with the strike rate utilizing:
(c₂−c₁)DV01=Exercise Price.
where,
c₁ is a fixed coupon;
c₂ is a fixed rate for a swap with a fixed rate that matches the option strike rate; and
DV01 is the sensitivity of a swap with respect to the change in the par swap rate.

6. The steps of claim 1 further comprising determining at least one discount curve consistent with the negotiated premium and corresponding rate-based strike rate further comprises using a London InterBank Offered Rate (LIBOR) curve.

7. The steps of claim 1 further comprising determining at least one discount curve consistent with the negotiated premium and corresponding rate-based strike rate further comprises using a London InterBank Offered Rate (LIBOR) curve and electronically implying or approximating the at least one discount curve further comprises using an overnight indexed swap (OIS) curve.

8. The steps of claim 1 further wherein the step of determining an adjustment factor further comprises determining an adjustment factor for a forward-starting swap.

9. The steps of claim 1 further comprising utilizing the adjustment factor to determine an exercise price of an underlying with a standardized coupon at expiration.

10. The steps of claim 1 further comprising utilizing the adjustment factor to determine a price of an underlying with a standardized coupon near expiration.

11. The steps of claim 1 further wherein the financial option is exchange traded.

12. The steps of claim 1 further wherein the financial option is over-the-counter.

13. The steps of claim 1 further comprising determining comprises implying, approximating, calculating, and combinations thereof.

14. The steps of claim 1 further including selecting the general-purpose digital computer from the group comprising one processor, more than one processor, and combinations thereof.

15. A general-purpose digital computer programmed to carry out a series of steps, the series of steps to electronically clear and settle a flexible-rate financial option comprising:
receiving a premium and a corresponding rate-based strike rate negotiated between two parties;
determining at least one discount curve representative of funding cost of market participants;
based on the at least one discount curve, determining an adjustment factor;
utilizing the adjustment factor to determine an exercise price of an underlying with a standardized coupon at or near the time of expiration;
whereby a financial option with rate-based strike rate and premium terms can be exercised into an underlying position in an equivalent standardized coupon financial instrument with a potentially different fixed rate and an exercise price.

16. The steps of claim 15 further comprising determining the exercise price of the underlying with a standardized coupon as the net present value of the present value difference between the delivered financial instrument with a fixed rate and a swap with the strike rate, at or near the time of option exercise.

17. The steps of claim 15 further wherein the step of determining an adjustment factor further comprises determining an adjustment factor for a forward-starting swap.

18. The steps of claim 15 further comprising utilizing the adjustment factor to determine an exercise price of an underlying with a standardized coupon at expiration.

19. The steps of claim 15 further comprising utilizing the adjustment factor to determine an exercise price of an underlying with a standardized coupon near expiration.

20. A computer program product, comprising a computer usable medium having a computer readable program code embodied therein, the computer readable program code adapted to be executed to implement a method for clearing and settling a flexible-rate financial option, the method comprising:
receiving a premium and a corresponding rate-based strike rate negotiated between two parties;
determining at least one discount curve representative of funding cost of market participants;
based on the at least one discount curve, determining an adjustment factor;
utilizing the adjustment factor to determine an exercise price of an underlying with a standardized coupon at or near the time of expiration;
whereby a financial option with rate-based strike rate and premium terms can be exercised into an underlying position in an equivalent standardized coupon financial instrument with a potentially different fixed rate and an exercise price.

21. The method of claim 20 further comprising determining at least one forward curve and at least one discount curve consistent with the negotiated coupon.

22. The method of claim 20 further comprising determining the exercise price of the underlying with a standardized coupon as the net present value of the difference between the fixed rate of the underlying and the option strike rate, at or near the time of option exercise.
